(19) United States
(12) Patent Application Publication
(10) Pub. No.: US 2025/0298557 A1
(43) Pub. Date: Sep. 25, 2025

(54) NON-TRANSITORY COMPUTER-READABLE STORAGE MEDIUM STORING SET OF INSTRUCTIONS FOR REGISTERING MEDIUM SIZE AS REGISTERED SIZE

(71) Applicant: BROTHER KOGYO KABUSHIKI KAISHA, Nagoya (JP)

(72) Inventor: Junjiro YOSHIDA, Nagoya (JP)

(21) Appl. No.: 19/056,370

(22) Filed: Feb. 18, 2025

(30) Foreign Application Priority Data
Mar. 22, 2024 (JP) 2024-047035

(51) Int. Cl. G06F 3/12; G06K 15/02

(52) U.S. Cl. CPC G06F 3/1208; G06F 3/1253; G06K 15/1843

(57) ABSTRACT

A non-transitory computer-readable storage medium stores a set of instructions for an information processing device including a controller. The set of instructions, when executed by the controller, causes the information processing device to perform an obtaining process, a registration process, a rendering process, a transmission process. The obtaining process includes obtaining print image information. The registration process includes registering, as a registered size, a medium size specified by the print image information. The rendering process includes rendering, based on the content specified by the print image information, a print image to fit a medium size among medium sizes registered as registered sizes that is the same as the medium size specified by the size-related information. The medium sizes include the medium size registered by the registration process and one or more medium sizes registered as registered sizes. The transmission process includes transmitting a print command to the printing device.

### REFERENCE TO RELATED APPLICATIONS

This application claims priority from Japanese Patent Application No. 2024-047035 filed on Mar. 22, 2024. The entire content of the priority application is incorporated herein by reference.

### BACKGROUND ART

A conventional program is executed on a PC to generate an image to be printed on a medium by a printing device. The program determines the size of the medium and controls the printing device to print the generated image on the medium having the determined size.

### SUMMARY

In order to obtain desired printing results with a system such as the conventional technology, an information processing device preferably generates an image of a suitable size for the size of the medium on which the image is to be printed. However, the image generated by the information processing device might be of an unintended size due to the configuration of the program used on the device or the content of the various data used by the program for generating images, for example.

In view of the foregoing, it is an object of the present disclosure to provide a technology capable of suppressing the generation of images of a size different from the desired size when an information processing device generates images to be printed by a printing device.

In order to attain the above and other objects, according to one aspect, the present disclosure provides a non-transitory computer-readable storage medium storing a set of instructions for an information processing device. The information processing device includes a controller. The set of instructions, when executed by the controller, causes the information processing device to perform an obtaining process, a registration process, a rendering process, a transmission process. The obtaining process includes obtaining print image information. The print image information includes image content information and size-related information. The image content information specifies a content of a print image printable by a printing device. The size-related information directly or indirectly specifies a medium size. The medium size is a size of a printing medium on which the print image is to be printed. The registration process includes registering, as a registered size, the medium size specified by the size-related information obtained in the obtaining process. The rendering process includes rendering, based on the content specified by the image content information obtained in the obtaining process, the print image to fit a medium size among a plurality of medium sizes registered as registered sizes that is the same as the medium size specified by the size-related information obtained in the obtaining process. The plurality of medium sizes includes the medium size registered by the registration process and one or more medium sizes registered as registered sizes. The transmission process includes transmitting a print command to the printing device. The print command includes information representing the print image rendered in the rendering process.

According to another aspect, the present disclosure provides an information processing device including a controller. The controller is configured to perform an obtaining process, a registration process, a rendering process, and a transmission process. The obtaining process includes obtaining print image information. The print image information includes image content information and size-related information. The image content information specifies a content of a print image printable by a printing device. The size-related information directly or indirectly specifies a medium size. The medium size is a size of a printing medium on which the print image is to be printed. The registration process includes registering, as a registered size, the medium size specified by the size-related information obtained in the obtaining process. The rendering process includes rendering, based on the content specified by the image content information obtained in the obtaining process, the print image to fit a medium size among a plurality of medium sizes registered as registered sizes that is the same as the medium size specified by the size-related information obtained in the obtaining process. The plurality of medium sizes includes the medium size registered by the registration process and one or more medium sizes registered as registered sizes. The transmission process includes transmitting a print command to the printing device. The print command includes information representing the print image rendered in the rendering process.

According to the above configuration, the medium size specified by the size-related information obtained in the obtaining process is registered as a registered size. As a result, the print image rendered in the rendering process is of a size suitable for this registered medium size. Hence, when the information processing device generates images to be printed by the printing device, the generated images can be suppressed from being of a different size than the desired size. In other words, the print image can be suppressed from being rendered in a state where the medium size specified by the obtained size-related information is not registered, e.g., the print image can be suppressed from being rendered according to a different registered size that does not conform to this medium size.

The above information processing device may be configured to perform the obtaining process, the registration process, the rendering process, and/or the transmission process according to a computer program, or using so-called wired logic.

### BRIEF DESCRIPTION OF DRAWINGS

FIG. 1 is a configuration diagram of a printing system.

FIG. 2 is a functional block diagram illustrating the functions of the printing system.

FIG. 3A is an explanatory diagram for explaining content of a medium information file.

FIG. 3B is an explanatory diagram for explaining content of a template file.

FIG. 3C is an explanatory diagram for explaining content of registered size information.

FIG. 4 is a diagram illustrating an example URL scheme and an example print image.

FIG. 5 is a sequence diagram illustrating an example operation of a print intermediary app.

FIG. 6 is a flowchart of a registration process.

### DESCRIPTION

Below, an illustrative embodiment of the present disclosure will be described.

### 1. Embodiment

### (1-1) Overview of a Printing System

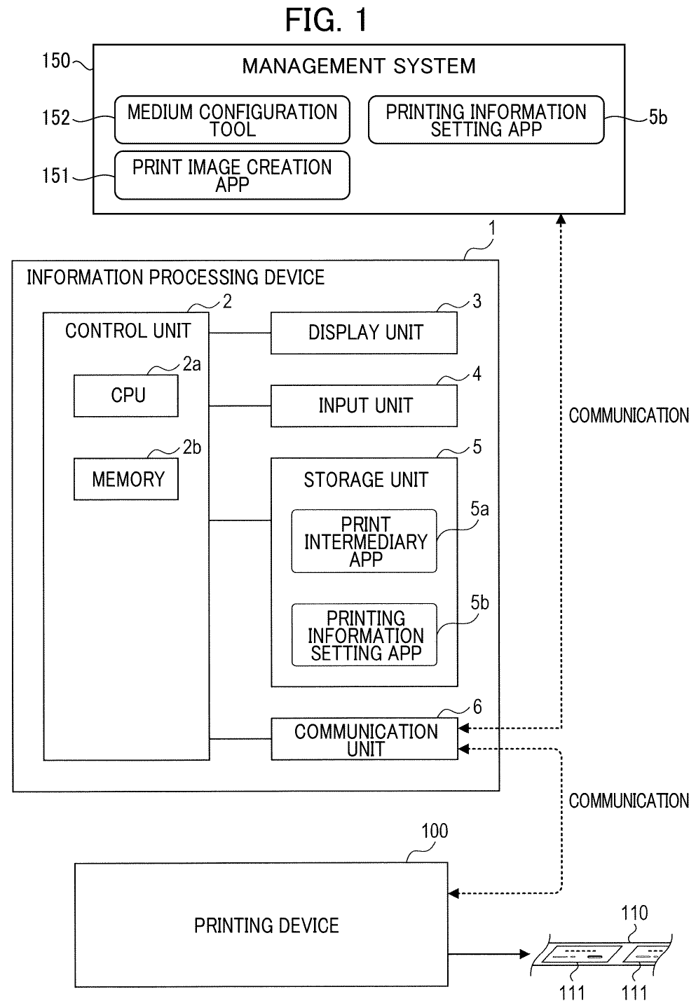

As shown in FIG. 1, a printing system according to the present embodiment includes an information processing device 1, a printing device 100, and a management system 150. The information processing device 1 can communicate with the printing device 100 and the management system 150.

The printing device 100 of the present embodiment is in the form of a label printer or a label writer. That is, a printing medium 110 used in the printing device 100 in this embodiment has a long-length and tape-like form. The printing device 100 is configured to print print images 111 on the printing medium 110 to be used as labels. The printing device 100 prints the print images 111 using one of various printing methods, such as a direct thermal printing method, a thermal transfer printing method, and an inkjet printing method. The printing medium 110 in this embodiment is provided in a roll form.

The printing medium 110 is accommodated in a cassette (not shown). The cassette is attachable to and detachable from the printing device 100. The print images 111 are printed along the longitudinal direction of the printing medium 110 (hereinafter referred to as the “medium length direction”). Note that the printing medium 110 may come in a form other than a long-length tape form.

The printing device 100 is configured to print, in response to receiving a print command specifying a print image 111 from the information processing device 1, the print image 111 specified in this print command on the printing medium 110. The printing device 100 prints the print image 111 on the printing medium 110 while drawing the printing medium 110 out of the cassette. The printing device 100 may be configured so that the printing medium 110 on which the print images 111 are printed is automatically or manually cut after each print image 111. Labels are affixed to name tags, file spines, retail price tags, postal envelopes, industrial materials, supplies, organizers, signs, and various other objects.

The management system 150 includes one or more information processing devices, for example. In this embodiment, the management system 150 will be assumed to have a single information processing device to simplify the description. An operating system (hereinafter referred to as “OS”) is installed on the management system 150. The OS may be Windows, for example. “Windows” is a registered trademark of Microsoft Corporation.

A print image creation app 151, a medium configuration tool 152, and a printer driver (not shown) are installed on the management system 150 as software running on the OS. Here, “app” is used as an abbreviation for “application software.”

The management system 150 also has a development environment in which arbitrary apps can be developed. The management system 150 has a printing information setting app 5b, which is an app developed in this development environment.

The information processing device 1 is in the form of a smartphone, tablet terminal, or portable or stationary personal computer, for example. The information processing device 1 includes a control unit 2, a display unit 3, an input unit 4, a storage unit 5, and a communication unit 6. The control unit 2 includes a CPU 2a, and a memory 2b. As a processor, the CPU 2a executes processes in accordance with computer programs stored in the memory 2b and the storage unit 5. The memory 2b may have semiconductor memory such as ROM, RAM, NVRAM, and flash memory.

The storage unit 5 includes such storage as a solid-state drive (SSD) and/or a hard disk drive (HDD) for storing various computer programs and data. In the present embodiment, the programs stored in the storage unit 5 include an OS. The OS may be Android or iOS, for example. “Android” is a registered trademark of Google LLC. “iOS” is a registered trademark of Cisco Technology, Inc.

Additionally, a print intermediary app 5a and the printing information setting app 5b described above are installed on the storage unit 5 as software running on the OS. The apps 5a and 5b may be installed in the storage unit 5 in any manner. For example, the apps 5a and 5b may be read from a storage medium such as a CD, DVD, or USB memory device and installed on the information processing device 1. Alternatively, the apps 5a and 5b may be downloaded from an external source (e.g., the management system 150) and installed on the information processing device 1. The apps 5a and 5b may also come preinstalled when the information processing device 1 is shipped from the factory. In the following description, the entity that executes a program (e.g., the control unit 2 in the information processing device 1) may be described simply by the program name or the software name. For example, the description “the print intermediary app 5a” may implicitly signify “the control unit 2 executing the print intermediary app 5a.”

The display unit 3 is configured to display various screens for the user. Examples of the display unit 3 include a liquid crystal display. The input unit 4 includes one or more input devices for receiving input operations from the user. Specifically, the input unit 4 may include a keyboard, a mouse, and/or a touch panel or may include input devices in other forms.

The communication unit 6 is configured to communicate with the printing device 100 and the management system 150. The print commands described above are transmitted to the printing device 100 from the communication unit 6. The communication unit 6 may use any method of communication to communicate with the printing device 100. For example, the communication unit 6 and printing device 100 may be configured to communicate with each other through a wired or wireless connection. Methods of wireless communication may include wireless LAN and Bluetooth, for example. “Bluetooth” is a registered trademark of Bluetooth SIG, Inc. Methods of wired communication may include Universal Serial Bus (USB) and wired LAN, for example. The same also applies to communication between the information processing device 1 and management system 150.

### (1-2) Functions of the Printing System

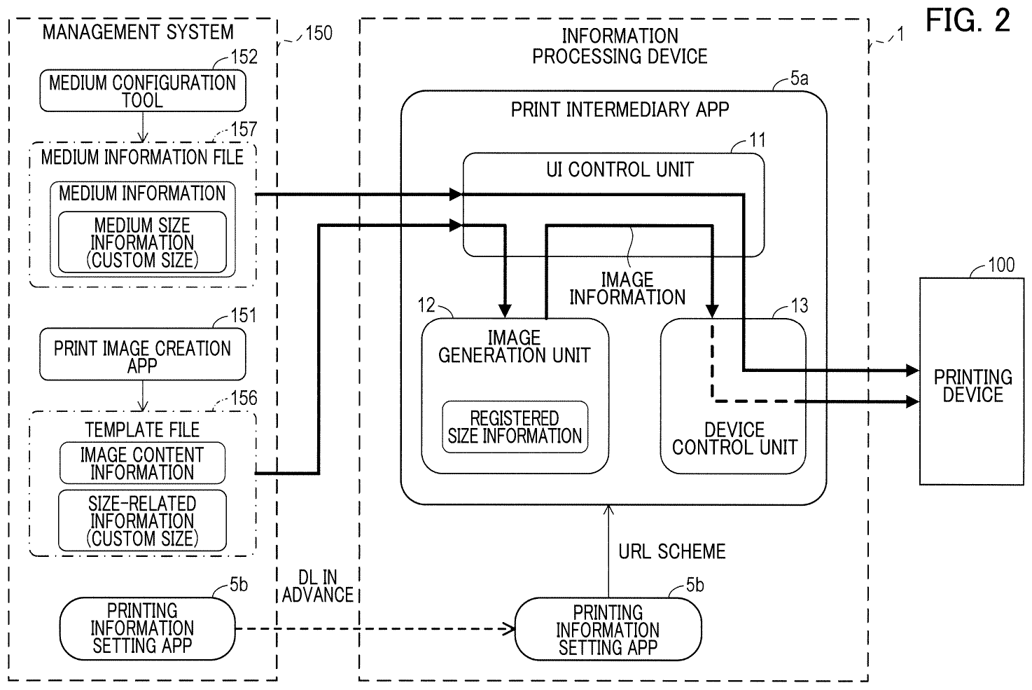

Various functions of the printing system will be described with reference to FIG. 2.

### (1-2-1) Medium Configuration Tool

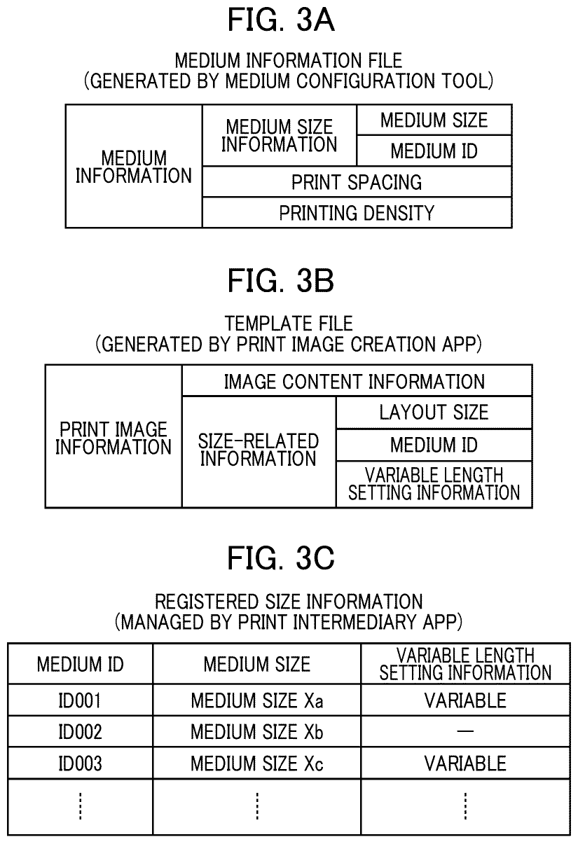

The medium configuration tool 152 can generate any new set of medium information (see FIGS. 2 and 3A) in accordance with user operations and can register this new medium information in the printer driver and on the printing device 100.

FIG. 3A shows one example of this medium information. In this example, the medium information includes medium size information, print spacing, printing density, and the like. The print spacing denotes the gap between two adjacent print images 111 when print images 111 are printed consecutively.

The medium size information specifies the size of the printing medium 110 (hereinafter called the “medium size”). The medium size information includes a medium ID, and the medium size specified by that medium ID (i.e., the medium size corresponding to that medium ID). For example, the medium size may be specified by the medium length (the length of the printing medium) and the medium width (the width of the printing medium), which are orthogonal to each other. In this embodiment, a different medium ID corresponds to each medium size. Here, “ID” is an abbreviation of “identification” and denotes an identifier, a code, a registration number, or the like.

The user can use the medium configuration tool 152 to register a new medium size not previously registered in the printer driver and on the printing device 100 (hereinafter called a “custom size”) in the printer driver and on the printing device 100.

In other words, medium information generated by the medium configuration tool 152 is registered in the printer driver on the management system 150. In this way, apps on the management system 150, including the print image creation app 151, can generate print images 111 having a layout size that conforms to the custom size. The “layout size” is the size of the print image 111, and specifically the size of a predetermined area that includes the print image 111, for example.

For each medium size, a layout size that conforms to (i.e., is compatible with) that medium size is set. Put another way, for each layout size, a medium size that conforms to (i.e., is compatible with) that layout size is set. Hence, the layout size can be considered to indirectly specify the medium size. A medium size and layout size having a mutually compatible relationship may be the same or different sizes. For example, a size that is a certain percentage smaller (e.g., a certain percentage smaller in width and/or length or a certain percentage smaller in area) than the medium size may be set as the layout size compatible with that medium size. In this embodiment, the medium size and the layout size compatible with that medium size (in other words, the layout size and the medium size compatible with that layout size) are the same size.

The medium configuration tool 152 also generates a medium information file 157 containing the generated medium information and saves the medium information file 157 in a storage device of the management system 150. The extension of the medium information file 157 is “.bin”, for example.

The medium information file 157 generated by the medium configuration tool 152 is transmitted (exported) to various external devices as necessary (e.g., in response to an external request). The various external devices include the information processing device 1 and printing device 100.

When the medium information file 157 is sent to the printing device 100, the printing device 100 registers the medium information in itself. As a result, the printing device 100 can print based on the newly registered medium information. That is, the printing device 100 can print print images 111 on a printing medium 110 of the newly registered custom size.

### (1-2-2) Print Image Creation App

The print image creation app 151 generates a template for the print image 111 according to user-inputted operations. The print image creation app 151 can generate templates that contain one or more objects. Objects can take various forms. For example, objects may be text, symbols, graphics, shapes, frames, barcodes, and databases.

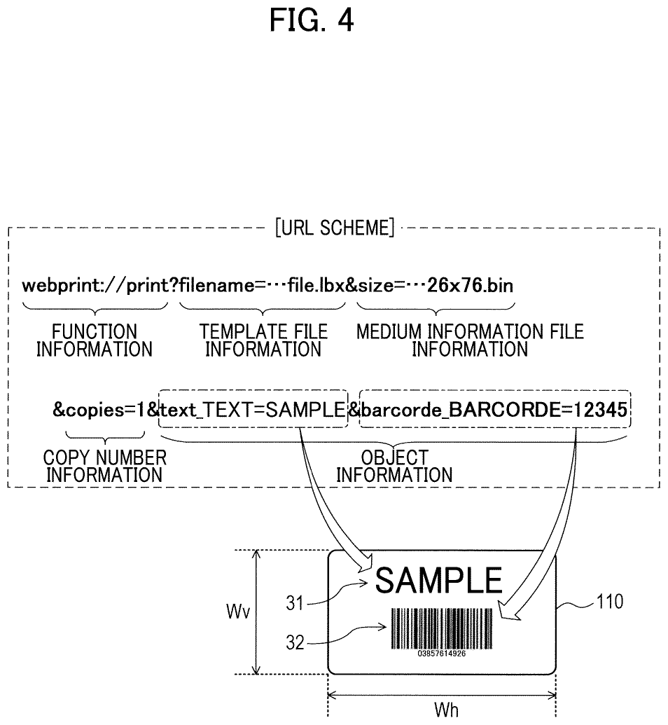

FIG. 4 shows an example of a print image 111 based on a template. The print image 111 in FIG. 4 includes a first object 31 and a second object 32. The first object 31 is in the form of text, while the second object 32 is in the form of a barcode. An object name is set for each object in the print image 111.

The print image creation app 151 saves the generated template as a template file 156 (see FIG. 2) in a storage device of the management system 150. The template file 156 has the extension “.lbx”, for example.

The template file 156 contains print image information. As shown in FIGS. 2 and 3B, print image information includes image content information and size-related information. The image content information specifies the content of the generated template, i.e., the content of the print image 111 that can be printed by the printing device 100.

As shown in FIG. 3B, the size-related information includes the layout size of the template, a medium ID, and variable length setting information. The layout size may be specified by a layout width Wv and a layout length Wh, as illustrated in the example of FIG. 4. In this embodiment, the layout width Wv and layout length Wh are respectively equivalent to the medium width and medium length of the medium size compatible with the layout size. Note that the layout length Wh can be adjusted to be longer or shorter according to the lengths of objects contained in the print image 111. Note that the layout size included in the size-related information indirectly specifies the medium size compatible with that layout size as described above, and hence, the size-related information can be considered to indirectly specify that medium size. Alternatively, the size-related information may directly specify the medium size compatible with the layout size contained in the size-related information. For example, the size-related information may contain the medium size itself or information indicating that medium size.

The medium ID included in the size-related information is the ID associated with the medium size compatible with the layout size of the template. Put another way, the layout size of the template (i.e., the layout size included in the size-related information) is the size compatible with the medium size associated with the medium ID included in the size-related information.

The variable length setting information indicates whether the medium length can be varied according to the length of the print image 111. Here, “medium length” is the dimension of the medium size for the portion corresponding to the length of the print image 111, and specifically the dimension of the portion corresponding to the layout length Wh in the present embodiment.

### (1-2-3) Print Information Setting App

As described above, the printing information setting app 5b is developed on the management system 150 and installed on the information processing device 1 (see FIG. 2), for example.

The printing information setting app 5b starts up the print intermediary app 5a and causes the print intermediary app 5a to generate the print image 111. A URL scheme is embedded in the printing information setting app 5b. The printing information setting app 5b uses the embedded URL scheme to launch the print intermediary app 5a. The printing information setting app 5b instructs the print intermediary app 5a to download the medium information file 157 and template file 156 from the management system 150. This instruction is issued through the URL scheme in the present embodiment.

The user can set each object of a template to an arbitrary value. That is, the printing information setting app 5b accepts a user-inputted value for each object in the template. The printing information setting app 5b then instructs the print intermediary app 5a to reflect these object values in the template. This instruction is also issued through the URL scheme in this embodiment.

FIG. 4 shows an example of a URL scheme. As shown in FIG. 4, the URL scheme in this embodiment includes function information, template file information, medium information file information, copy number information, and object information.

The function information is an instruction directed to the OS and specifies a function to be executed by the OS according to the instruction. When the URL scheme is issued, the OS executes the function specified by the function information. In the present embodiment, the function information includes instructions to start up the print intermediary app 5a and execute a print. Accordingly, when this URL scheme is received, the OS starts up the print intermediary app 5a.

The template file information specifies the location and filename for the template file 156. The medium information file information specifies the location and filename for the medium information file 157. The copy number information indicates the number of copies of the print image 111 to be printed based on the template.

The object information specifies a value to be set for each object. Put another way, the object information could be considered commands that instruct the print intermediary app 5a to set the value for each object in the template to the value specified in the object information.

### (1-2-4) Print Intermediary App

When started up by the URL scheme, the print intermediary app 5a executes various processes in accordance with the URL scheme. In the present embodiment, the print intermediary app 5a downloads the template file 156 and medium information file 157 from the management system 150 and renders or draws (i.e., generates) a print image 111 based on the template and object information in accordance with the URL scheme shown in FIG. 4. The print intermediary app 5a then transmits, to the printing device 100, the medium information file 157 and a print command containing image information (image data) of the generated print image 111.

One or more medium sizes are recorded in the print intermediary app 5a as “registered sizes.” Specifically, each medium size is registered together with the medium ID associated with that medium size. As described above, a medium ID is set for each medium size. When rendering a print image 111, the print intermediary app 5a renders the print image in a layout size that conforms to one of the registered sizes. This process will be described later in greater detail.

The print intermediary app 5a includes three modules. In the specific example of FIG. 2, the print intermediary app 5a includes a UI control unit 11, an image generating unit 12, and a device control unit 13.

The UI control unit 11 passes the downloaded template file 156 to the image generating unit 12. The UI control unit 11 also passes image information of the print image 111 rendered by the image generating unit 12 to the device control unit 13. The UI control unit 11 further passes the downloaded medium information file 157 to the device control unit 13.

The image generating unit 12 renders a print image 111 based on the template specified in the template file 156, and the object information specified in the URL scheme. The image generating unit 12 possesses registered size information (see FIGS. 2 and 3C). As shown in the example of FIG. 3C, the registered size information includes medium sizes registered as registered sizes, the medium IDs associated with these medium sizes, and variable length setting information. The image generating unit 12 can render a print image 111 at a layout size conforming to a registered medium size. When a medium size compatible with the layout size contained in the template file 156 is registered, the image generating unit 12 renders the print image 111 at this layout size. When the variable length setting information associated with that medium size indicates that the medium length is variable, the image generating unit 12 renders the print image 111 with a layout length Wh corresponding to the length of the objects in the image and, hence, the printing device 100 prints this print image 111 on the printing medium 110 with a medium length corresponding to this layout length Wh. The process used for cases in which a medium size conforming to the layout size contained in the template file 156 has not been registered is one of the features of this embodiment and will be described later in greater detail.

The device control unit 13 generates a print command based on the image information received from the image generating unit 12. The print command includes a command specifying image information of the generated print image 111, and commands for controlling the printing device 100. The device control unit 13 further controls communications with the printing device 100. The device control unit 13 sends the print command and the medium information file 157 to the printing device 100 via the communication unit 6.

### (1-2-5) Distinctive Functions of the Printing System

Here, distinctive functions implemented by the printing system of the present embodiment will be described with reference to FIGS. 2 through 4.

The user of the information processing device 1 can use the print intermediary app 5a and printing information setting app 5b to generate print images 111 having desired content and to print these print images 111 on the printing device 100 (see FIG. 2). At this time, it is, basically, the printing information setting app 5b that the user operates directly.

The user can use the printing information setting app 5b to specify any value for each of the objects in the template. The user specifies the value of the object through an input operation on the input unit 4, for example.

When the user has inputted a value for each object and performed a prescribed operation to issue a print instruction, the printing information setting app 5b issues a URL scheme containing the inputted object values (see FIG. 4). When the URL scheme is issued, the OS starts up the print intermediary app 5a.

Upon startup, the print intermediary app 5a performs various processes in accordance with the URL scheme. Specifically, the UI control unit 11 accesses the locations in which the template file 156 and medium information file 157 are stored (prescribed storage areas of the management system 150 in the present embodiment) according to the template file information and medium information file information included in the URL scheme and downloads the template file 156 and medium information file 157.

Next, the image generating unit 12 renders a print image 111 based on the template in a prescribed rendering area of the storage unit 5 in accordance with the print image information (see FIG. 3B) provided by the template file 156, various values provided by the URL scheme, and registered size information (see FIG. 3C) registered in the print intermediary app 5a.

Generally, the image generating unit 12 renders the print image 111 at the layout size included in the print image information. However, this assumes that a medium size conforming to that layout size has been registered in the print intermediary app 5a as a registered size.

If the image generating unit 12 rendered the print image 111 at a layout size conforming to one of the registered medium sizes when a medium size conforming to the layout size in the template file 156 had not been registered in the print intermediary app 5a, the print image 111 might be generated and printed at a different size from the layout size originally intended (first concern).

Further, even if a print image is properly generated at the layout size in the template file 156, if a medium size compatible with that layout size has not been registered on the printing device 100, the print image 111 will be printed on a printing medium 110 having a medium size that does not match (e.g., is too large or too small) this layout size (the second concern).

Therefore, the print intermediary app 5a of the present embodiment is provided with a medium size registration function, and a medium information file transfer function. The medium size registration function resolves the first concern, while the medium information file transfer function resolves the second concern.

The medium size registration function is primarily implemented by the image generating unit 12. An overview of the medium size registration function is as follows. When a medium size compatible with the layout size of the downloaded template has not been registered, the print intermediary app 5a newly registers a medium size compatible with this layout size as a registered size prior to performing the rendering. This new registration of a medium size is one of the most distinctive features of this embodiment and will be described later in greater detail.

The medium information file transfer function is primarily implemented by the device control unit 13. Through this function, the device control unit 13 transfers the medium information file 157 downloaded from the management system 150 to the printing device 100. As described above, the device control unit 13 sends the medium information file 157 to the printing device 100 together with the print command.

After registering a new medium size according to the medium size registration function, the image generating unit 12 renders the print image 111 according to the above principle. In other words, based on the fact that a medium size compatible with the layout size has been registered as a registered size, the image generating unit 12 renders the print image 111 at this layout size. In the process, the image generating unit 12 sets the values of objects in the print image 111 to the values provided in the URL scheme.

The device control unit 13 transmits the print image 111 rendered by the image generating unit 12 to the printing device 100 in the form of a print command. The device control unit 13 also sends the medium information file 157 at this time.

Upon receiving the medium information file 157, the printing device 100 newly registers the medium size specified by the medium information file 157 on the printing device 100. As a result, the printing device 100 can print a print image on the printing medium 110 at the newly registered medium size.

Next, the printing device 100 prints the print image 111 specified in the print command received from the device control unit 13 on the printing medium 110. If a printing medium 110 of the medium size specified by the medium information file 157 is mounted in the printing device 100 at this time, the printing device 100 prints the print image on that printing medium 110.

### (1-3) Print Image Generation Process

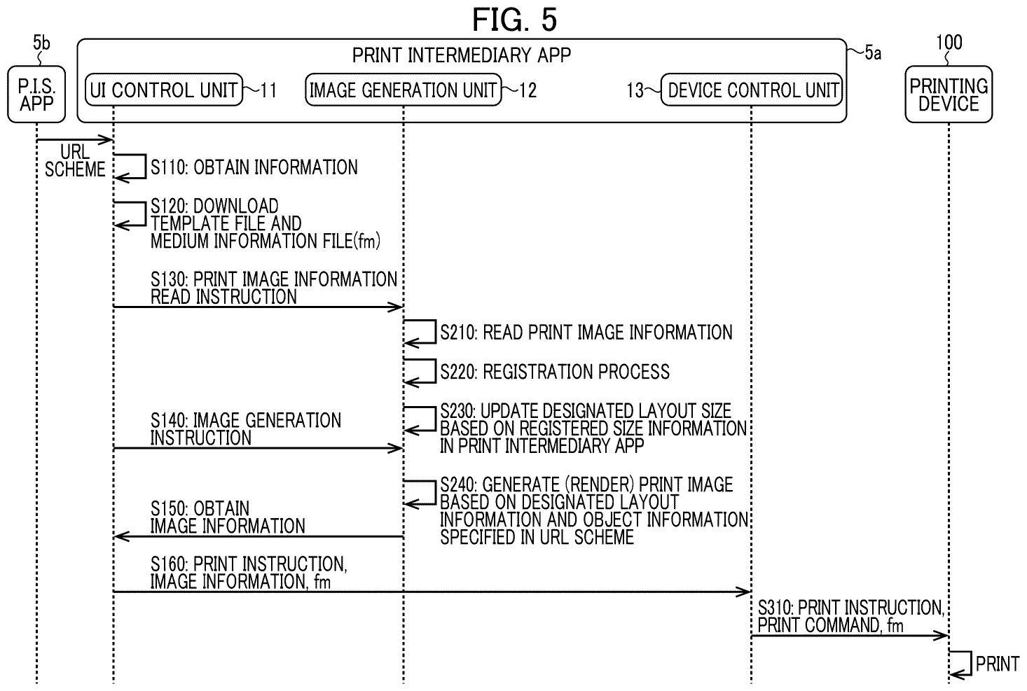

A print image generation process executed by the control unit 2 (and specifically the CPU 2a) of the information processing device 1 to implement the distinctive functions described above will be described with reference to FIG. 5. The control unit 2 implements the print image generation process by executing a program included in the print intermediary app 5a supporting the print image generation process. “P.I.S. App” in FIG. 5 denotes the printing information setting app 5b.

When the printing information setting app 5b issues a URL scheme (see FIG. 4), the control unit 2 starts up the print intermediary app 5a in accordance with this URL scheme. When started up by the URL scheme, the print intermediary app 5a begins the print image generation process.

In S110 at the beginning of the print image generation process, the UI control unit 11 obtains various information specified in the URL scheme, and specifically the function information, template file information, medium information file information, copy number information, and object information.

In S120 the UI control unit 11 downloads the template file 156 and medium information file 157 from the management system 150 using the template file information and medium information file information obtained in S110. That is, in S120 the control unit 2 (the CPU 2a) obtains the print image information included in the template file 156. Hereinafter, the template file 156 will be sometimes referred to simply as the “template”.

In S130 the UI control unit 11 instructs the image generating unit 12 to read the print image information from the template file 156.

Upon receiving this instruction in S130, in S210 the image generating unit 12 reads the print image information from the template file 156 and develops this information in a predetermined work area of the storage unit 5. Subsequent processing by the image generating unit 12 targets the print image information developed in this work area (see FIG. 3B).

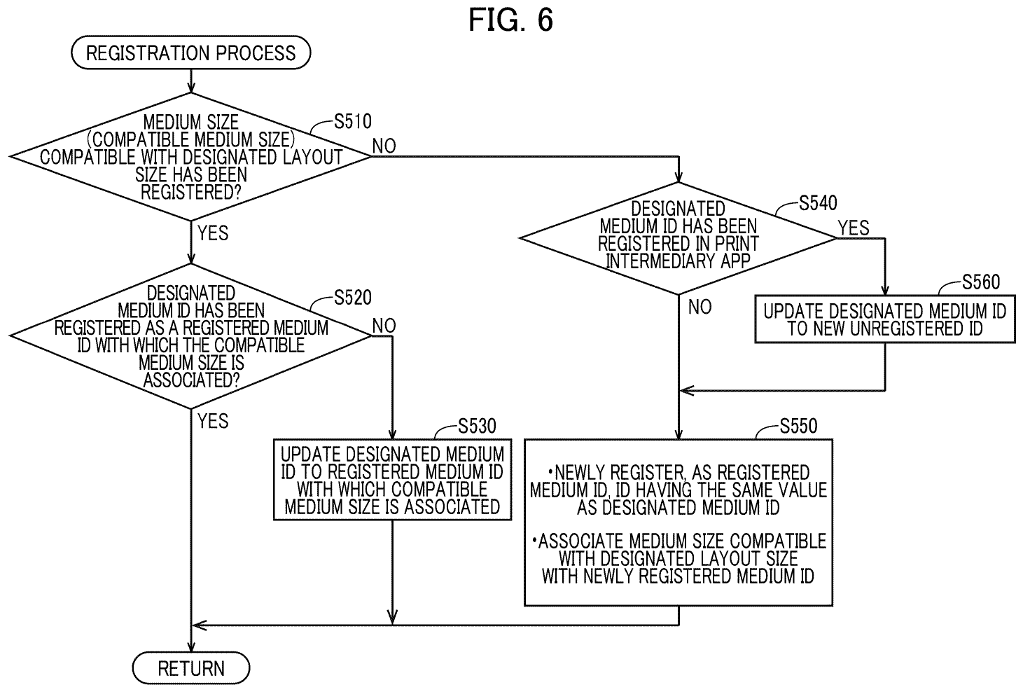

In S220 the image generating unit 12 executes a registration process. The main process of the registration process is to newly register a medium size compatible with the layout size included in the print image information when that medium size has not been registered in the print intermediary app 5a. The registration process will be described in detail with reference to FIG. 6.

After initiating the registration process, in S510 the image generating unit 12 determines whether a medium size compatible with the designated layout size (hereinafter called a “compatible medium size”) has been registered in the print intermediary app 5a as a registered size (see FIG. 3C). The “designated layout size” refers to the layout size specified in the print image information (and specifically the size-related information) of the template downloaded in S120 (see FIG. 3B). The process advances to S520 when the compatible medium size has already been registered as a registered size (S510: YES). In other words, the process advances to S520 when the medium sizes registered as registered medium sizes in the print intermediary app 5a include the medium size that is the same as the compatible medium size.

In S520 the image generating unit 12 determines whether the designated medium ID is registered in the print intermediary app 5a as a registered medium ID to which the compatible medium size is associated. The “designated medium ID” refers to the medium ID specified in the print image information (and specifically the size-related information) of the template downloaded in S120 (see FIG. 3B). A “registered medium ID” is a medium ID registered in the print intermediary app 5a as a registered medium ID (see FIG. 3C).

The process of S520 can be considered a process to determine whether both requirements A and B described next have been satisfied. Requirement A is that a medium ID identical to the designated medium ID has been registered. Requirement B is that the compatible medium size has been associated with that registered medium ID.

When the image generating unit 12 determines in S520 that the designated medium ID has already been registered (i.e., that both requirements A and B are satisfied; S520: YES), the process proceeds to S230 (see FIG. 5). When the image generating unit 12 determines in S520 that the designated medium ID has not been registered (S520: NO), the process advances to S530.

In S530 the image generating unit 12 updates the designated medium ID that has been developed in the work area to the registered medium ID with which the compatible medium size associated with in the print intermediary app 5a. Following the process of S530, the process advances to S230 (see FIG. 5).

When the image generating unit 12 determines in S510 that the compatible medium size is not registered as a registered size (S510: NO), the process advances to S540. In other words, when the medium sizes registered as registered medium sizes in the print intermediary app 5a do not include any medium size that is the same as the compatible medium size, the process advances to S540.

In S540 the image generating unit 12 determines whether the designated medium ID has been registered in the print intermediary app 5a as a registered medium ID (see FIG. 3C). When the designated medium ID is not registered in the print intermediary app 5a (S540: NO), the process advances to S550. In other words, when the medium IDs registered as registered medium IDs in the print intermediary app 5a do not include any medium ID having the same value as the value of the designated medium ID, the process advances to S550. When the designated medium ID is registered in the print intermediary app 5a (S540: YES), the process advances to S560. In other words, when the medium IDs registered as registered medium IDs in the print intermediary app 5a include the registered medium ID having the same value as the value of the designated medium ID, the process advances to S560.

In S560 the image generating unit 12 creates a new unregistered ID. A “new unregistered ID” is an ID that does not duplicate any medium IDs registered as registered medium IDs (an ID that has not yet been registered). The image generating unit 12 then updates the current designated medium ID developed in the work area to the new unregistered ID created above. Following S560, the process advances to S550. In other words, the image generating unit 12 updates the value of the medium ID included in the size-related information to the same value as the value of the new unregistered ID created above.

In S550 the image generating unit 12 newly registers an ID having the same value as the designated medium ID as a new registered medium ID (and hence, as a registered medium ID). When the process advances to S550 from S560, the image generating unit 12 newly registers a registered medium ID having the same value as the latest designated medium ID just updated in S560. The image generating unit 12 then associates the medium size compatible with the designated layout size with the newly registered medium ID. In other words, the image generating unit 12 registers the medium size compatible with the designated layout size in the print intermediary app 5a as a registered size in association with the newly registered medium ID. At this time, the variable length setting information included in the print image information is registered in associated with the registered medium ID. In other words, when the variable length setting information specifies that the medium length is variable, the image generating unit 12 registers the medium size compatible with the designated layout size as a medium size whose medium length is variable according to the length of the print image 111. Following S550, the process advances to S230 (see FIG. 5).

Here, the registration process of S220 will be described in detail for several possible situations. As one example, it is assumed that the three medium sizes shown in FIG. 3C are registered in the print intermediary app 5a. Now, it is also assumed that the designated medium ID is “ID002”, and the designated layout size is a size “Lb”, which is compatible with the medium size “Xb”. As described above, “Xb” may be the same as or different from “Lb”.

In this hypothetical example, the registered medium ID “ID002” registered in the print intermediary app 5a is the same as the designated medium ID, and the registered medium size “Xb” associated with the registered medium ID “ID002” is also compatible with the designated layout size “Lb”. Accordingly, the image generating unit 12 reaches a positive determination in both S510 and S520 in this example and advances to S230.

On the other hand, it is assumed that the designated medium ID is “ID002” as in the above example, but that the designated layout size is a size “Lz”, which is different from the layout size compatible with the medium size “Xb” associated with the registered medium ID “ID002”. In this hypothetical example, the process advances from S510 to S560 via S540. In S560 the image generating unit 12 creates a new unregistered ID (e.g., “ID100”) and updates the designated medium ID developed in the work area to this “ID100”. In S550 the image generating unit 12 also newly registers the medium ID “ID100” as a registered medium ID. Lastly, the image generating unit 12 newly registers the medium size “Xz”, which is compatible with the designated layout size “Lz”, in association with this registered medium ID “ID100”. In this example, the medium size “Xz” is an example of the “medium size registered by the registration process” of the present disclosure, and the medium sizes “Xa”, “Xb”, “Xc” are an example of the “one or more medium sizes registered as registered sizes” of the present disclosure.

As another example, it is assumed that the designated layout size is the size “Lb”, which is compatible with the medium size “Xb” associated with the registered medium ID “ID002”, but that the designated medium ID is “ID200”, which is not registered as a registered medium ID. In this hypothetical example, the process advances from S510 to S530 via S520. In S530 the image generating unit 12 updates the designated medium ID developed in the work area to “ID002”.

As another example, it is assumed that the designated medium ID is “ID300”, the designated layout size is “Ly”, and the medium size compatible with this designated layout size “Ly” is “Xy”. In this case, neither the designated medium ID “ID300” nor the medium size “Xy” is included in the registered size information. In other words, neither the designated medium ID “ID300” nor the medium size “Xy” is registered in the print intermediary app 5a. Therefore, in this hypothetical example, the process advances from S510 to S550 via S540. In S550 the image generating unit 12 newly registers the designated medium ID “ID300” as a registered medium ID and also newly registers the medium size “Xy” in association with this registered medium ID “ID300”. In this example, the medium size “Xy” is an example of the “medium size registered by the registration process” of the present disclosure, and the medium sizes “Xa”, “Xb”, “Xc” are an example of the “one or more medium sizes registered as registered sizes” of the present disclosure.

Returning to the description in FIG. 5, in S230 the image generating unit 12 updates the layout size developed in the work area based on the registered size information in the print intermediary app 5a. Specifically, the image generating unit 12 obtains the medium size associated with the registered medium ID that is the same as the designated medium ID. The image generating unit 12 then updates the designated layout size to the layout size compatible with the obtained medium size.

By performing the registration process of S220, the designated layout size will generally match the size compatible with the medium size associated with the registered medium ID that is the same as the designated medium ID. Therefore, the process of S230 may be omitted.

After the image generating unit 12 completes the process of S230 (or S220 when S230 is omitted), in S140 the UI control unit 11 instructs the image generating unit 12 to generate a print image.

Upon receiving this instruction in S140, in S240 the image generating unit 12 renders a print image 111 based on the content specified in the image content information, the latest designated layout size at that time, and the object information specified in the URL scheme. In other words, in S240 the image generating unit 12 renders a print image 111 to fit a medium size among the medium sizes registered as registered sizes that is the same as the medium size specified by the size-related information (i.e., the medium size compatible with the latest designated layout size).

In S150 the UI control unit 11 obtains, from the image generating unit 12, image information representing the print image 111 generated in S240. In S160 the UI control unit 11 issues a print instruction to the device control unit 13. Specifically, the UI control unit 11 passes the image information obtained from the image generating unit 12 and the medium information file 157 downloaded in S120 to the device control unit 13.

Upon receiving this print instruction in S160, in S310 the device control unit 13 transmits a print instruction to the printing device 100 via the communication unit 6. Specifically, the device control unit 13 generates a print command containing the image information and transmits this print command to the printing device 100 together with the medium information file 157.

As a result, the medium information is registered on the printing device 100 based on the medium information file 157. The printing device 100 then prints the print image 111 in accordance with the print command (i.e., the print image 111 rendered in S240) on a printing medium 110 having the registered medium size (i.e., the medium size indicated by the medium size information included in the registered medium information). That is, the print command is a command instructing the printing device 100 to print the print image 111 on the printing medium 110 of the medium size indicated by the medium size information included in the registered medium information.

### (1-4) Effects of the Embodiment

According to the embodiment described above, the image generating unit 12 performs a registration process based on the size-related information contained in the template file 156, and the registration status of registered sizes in the print intermediary app 5a. Through this registration process, the medium size compatible with the designated layout size is registered as a registered size, and the designated medium ID is registered as a registered medium ID. As a result, the image generating unit 12 can render a print image 111 at an appropriate size (i.e., the designated layout size). If the medium size compatible with the designated layout size were not registered as a registered size, the image generating unit 12 might be unable to render a print image 11 properly at the designated layout size, and the print image 111 might be rendered at an unintended size. However, the image generating unit 12 in this embodiment registers the medium size compatible with the designated layout size as a registered size in such cases. This suppresses the print image 111 from being rendered at an unintended size.

A particular feature of this embodiment is that a suitable process is performed for each of the following cases (i)-(iii). As a result, the medium size compatible with the designated layout size is registered as a registered size, and the designated medium ID is registered as a registered medium ID.

(i) A case in which the medium size compatible with the designated layout size has not been registered but the same registered medium ID as the designated medium ID has been registered (S540: YES). That is, a case in which the medium size not compatible with the designated layout size has been associated with a registered medium ID that is the same as the designated medium ID.

(ii) A case in which the medium size compatible with the designated layout size has been registered, but the registered medium ID associated with that compatible medium size differs from the designated medium ID (S520: NO).

(iii) A case in which the medium size compatible with the designated layout size has not been registered and the same registered medium ID as the designated medium ID also has not been registered (S540: NO).

The storage included in the storage unit 5 is an example of the non-transitory computer-readable storage medium of the present disclosure. The print intermediary app 5a is an example of the set of instructions of the present disclosure. The control unit 2 is an example of the controller of the present disclosure. The medium ID included in the template file 156 is an example of the first ID of the present disclosure. The medium IDs registered as registered medium IDs are each an example of the second ID of the present disclosure. The process in S120 is an example of the obtaining process of the present disclosure. The process in S240 is an example of the rendering process of the present disclosure. The process in S310 is an example of the transmission process of the present disclosure. The process in S560 is an example of the first process of the present disclosure. The process in S550 is an example of the second process.

### 2. Other Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

(2-1) In the above embodiment, the print intermediary app 5a includes three program modules: the UI control unit 11, the image generating unit 12, and the device control unit 13. However, the print intermediary app 5a may be configured in various other ways. That is, the functions of the print intermediary app 5a may be implemented through one, two, or four or more program modules.

For example, one module may execute steps S110, S120, S210-S240, and S310 to achieve the functions of the print intermediary app 5a shown in FIG. 5.

(2-2) When the designated layout size is equivalent to the medium size associated with the designated medium ID, the designated layout size may be treated as the medium size corresponding to the designated medium ID. In other words, the template file 156 may be considered to include the medium ID and the medium size corresponding to that medium ID.

(2-3) It is not mandatory that the medium size be managed together with the medium ID. The management (including registration) of medium sizes may be achieved without a medium ID. In this case, when the medium size compatible with the designated layout size has not been registered as a registered size, the image generating unit 12 may newly register the compatible medium size as a registered size in the registration process of S220.

(2-4) In the above embodiment, the printing information setting app 5b is installed on the information processing device 1. That is, the above embodiment gives an example in which the printing information setting app 5b is provided to the information processing device 1 in the form of a native application. However, the printing information setting app 5b may be provided in a form different from that of a native application. For example, rather than being installed on the information processing device 1, the printing information setting app 5b may be provided on the management system 150 in the form of a web application. Specifically, the information processing device 1 may be provided with a web browser, and the user may be able to execute the printing information setting app 5b on the management system 150 and input various information and the like through this web browser. In this case, the management system 150 may provide a URL scheme to the information processing device 1, and the print intermediary app 5a may be started up in accordance with that URL scheme.

(2-5) The layout size contained in the template file 156 (see FIG. 3B) and each medium size included in the registered size information (i.e., each registered size; see FIG. 3C) may include margin information. Margins are areas in which images are not drawn. The margin information may include the position and the range and/or size of each margin, for example.

The “compatible medium size” in S510 may be a medium size having a size compatible with the designated layout size and having margins matching the margins in the designated layout size. In other words, the conditions for determining that the designated layout size and registered size are compatible with each other may also include that their margins match. Here, “match” may signify that the margins are an exact match or may signify that at least a predetermined percentage of the margins match.

(2-6) A plurality of functions possessed by a single component in the above embodiments may be implemented by a plurality of components, and a single function possessed by a single component may be implemented by a plurality of components. Similarly, a plurality of functions possessed by a plurality of components may be implemented by a single component, and a single function implemented by a plurality of components may be implemented by a single component. Additionally, some of the structures in the above embodiments may be omitted.

What is claimed is:

1. A non-transitory computer-readable storage medium storing a set of instructions for an information processing device comprising a controller, the set of instructions, when executed by the controller, causing the information processing device to perform:
an obtaining process comprising obtaining print image information including:
image content information specifying a content of a print image printable by a printing device; and
size-related information directly or indirectly specifying a medium size, the medium size being a size of a printing medium on which the print image is to be printed;
a registration process comprising registering, as a registered size, the medium size specified by the size-related information obtained in the obtaining process;
a rendering process comprising rendering, based on the content specified by the image content information obtained in the obtaining process, the print image to fit a medium size among a plurality of medium sizes registered as registered sizes that is the same as the medium size specified by the size-related information obtained in the obtaining process, the plurality of medium sizes including the medium size registered by the registration process and one or more medium sizes registered as registered sizes; and
a transmission process comprising transmitting a print command to the printing device, the print command including information representing the print image rendered in the rendering process.

2. The non-transitory computer-readable storage medium according to claim 1,
wherein the transmission process further comprises transmitting medium size information to the printing device, the medium size information indicating the medium size specified by the size-related information obtained in the obtaining process, and
wherein the print command is a command instructing the printing device to print the print image on the printing medium of the medium size indicated by the medium size information.

3. The non-transitory computer-readable storage medium according to claim 1,
wherein the registering in the registration process is performed when the medium size specified by the size-related information obtained in the obtaining process has not been registered as a registered size.

4. The non-transitory computer-readable storage medium according to claim 1,
wherein the size-related information obtained in the obtaining process includes a first identifier in association with the medium size specified by the size-related information obtained in the obtaining process,
wherein one or more second identifiers corresponding to the one or more medium sizes registered as the registered sizes are registered as registered identifiers with each of the one or more second identifiers associated with a corresponding one of the one or more medium sizes, and
wherein, when the one or more second identifiers registered as the registered identifiers do not include any second identifier having the same value as a value of the first identifier, the registration process further comprises:
newly registering, as a registered identifier, a second identifier having the same value as the value of the first identifier in association with the medium size associated with the first identifier in the size-related information obtained in the obtaining process.

5. The non-transitory computer-readable storage medium according to claim 1,
wherein the size-related information obtained in the obtaining process includes a first identifier in association with the medium size specified by the size-related information obtained in the obtaining process,
wherein one or more second identifiers corresponding to the one or more medium sizes registered as the registered sizes are registered as registered identifiers with each of the one or more second identifiers associated with a corresponding one of the one or more medium sizes, and
wherein, when the one or more second identifiers registered as the registered identifiers include the second identifier having the same value as a value of the first identifier but the medium size registered in association with the second identifier having the same value as the value of the first identifier is different from the medium size associated with the first identifier in the size-related information obtained in the obtaining process, the registration process further comprises:
a first process comprising:
creating a new second identifier having a value different from a value of the second identifier having the same value as the value of the first identifier; and
updating the value of the first identifier included in the size-related information to the same value as the value of the new second identifier; and
a second process after completing the first process, the second process comprising:
newly registering, as a registered identifier, the new second identifier created in the first process in association with the medium size associated with the first identifier in the size-related information obtained in the obtaining process.

6. The non-transitory computer-readable storage medium according to claim 1,
wherein the size-related information obtained in the obtaining process includes a first identifier in association with the medium size specified by the size-related information obtained in the obtaining process,
wherein one or more second identifiers corresponding to the one or more medium sizes registered as the registered sizes are registered as registered identifiers with each of the one or more second identifiers associated with a corresponding one of the one or more medium sizes, and
wherein, when the one or more medium sizes registered as the registered sizes include the medium size that is the same as the medium size associated with the first identifier but that is registered in association with the second identifier having a different value from a value of the first identifier, the registration process comprises, instead of the registering the medium size specified by the size-related information obtained in the obtaining process:
updating the value of the first identifier included in the size-related information to the different value of the second identifier.

7. The non-transitory computer-readable storage medium according to claim 1,
wherein the medium size includes a medium length, the medium length being a length corresponding to a length of the print image,
wherein the print image information includes variable length setting information indicating whether or not the medium length is variable according to the length of the print image, and
wherein, when the variable length setting information included in the print image information obtained in the obtaining process indicates that the medium length is variable, the registering in the registration process registers, as a registered size whose medium length is variable according to the length of the print image, the medium size specified by the size-related information obtained in the obtaining process.

8. An information processing device comprising:
a controller configured to perform:
an obtaining process comprising obtaining print image information including:
image content information specifying a content of a print image printable by a printing device; and
size-related information directly or indirectly specifying a medium size, the medium size being a size of a printing medium on which the print image is to be printed;
a registration process comprising registering, as a registered size, the medium size specified by the size-related information obtained in the obtaining process;
a rendering process comprising rendering, based on the content specified by the image content information obtained in the obtaining process, the print image to fit a medium size among a plurality of medium sizes registered as registered sizes that is the same as the medium size specified by the size-related information obtained in the obtaining process, the plurality of medium sizes including the medium size registered by the registration process and one or more medium sizes registered as registered sizes; and
a transmission process comprising transmitting a print command to the printing device, the print command including information representing the print image rendered in the rendering process.
